(19) United States
(12) Patent Application Publication
(10) Pub. No.: US 2014/0026637 A1
(43) Pub. Date: Jan. 30, 2014

(54) MICRO-DEVICE FOR ANALYSIS BY GAS PHASE CHROMATOGRAPHY OFFERING GREAT COMPACTNESS

(71) Applicant: Commissariat A L'Energie Atomique et aux Ene Alt, Paris (FR)

(72) Inventors: Henri BLANC, Grenoble (FR); Julien Arcamone, St Martin Le Vinoux (FR)

(73) Assignee: COMMISSARIAT A L'ENERGIE ATOMIQUE ET AUX ENE ALT, Paris (FR)

(21) Appl. No.: 13/949,706

(22) Filed: Jul. 24, 2013

(30) Foreign Application Priority Data
Jul. 26, 2012 (FR) 12 57260

(51) Int. Cl. G01N 30/60

(52) U.S. Cl. CPC G01N 30/6095
USPC 73/23.39

(57) ABSTRACT

Device for analysis by gas phase chromatography comprising:
a chromatography micro-column,
a detection module comprising at least one NEMS and/or MEMS type detector arranged in channel,
a direct fluidic connection between an evacuation end of the chromatography micro-column and an admission end of the channel of the detection module,
a thermoelectric module, the hot face heating the chromatography micro-column and the cold face cooling the detection module.

### TECHNICAL FIELD AND PRIOR ART

The present invention relates to a micro-device for analysis by gas phase chromatography offering great compactness.

A micro-device for analysis by gas phase chromatography comprises an injector, one or more micro-columns, and one or more detectors based on NEMS (nanoelectromechanical systems) and MEMS (microelectromechanical systems) connected in series with the micro-column(s) and an electronic for processing the electrical signal(s) emitted by the detectors. Such a micro-device is for example used for the analysis and the detection of gases.

In order to ensure good separation of species in the micro-column and more selective detection on the detectors, a chemical functionalization is carried out on the internal walls of the columns and on the sensitive elements of the detectors.

In order that the column fulfils as best as possible its function of spatial interval of species, it is preferable to heat it above ambient temperature, to a temperature varying as a function of the products to be analysed, generally between 50° C. and 200° C. Furthermore, in certain cases, it may be interesting to cool below ambient temperature the detector(s), in order to improve the trapping effect of the gaseous compounds by physisorption: for example between +10° C., and −20° C.

The document WO 2011/133721 describes a micro-device for analysis by chromatography comprising means for heating and/or cooling the micro-column formed by a thermoelectric module and means for heating the detectors.

### DESCRIPTION OF THE INVENTION

It is an aim of the present invention to offer a device for analysis by gas phase chromatography offering great compactness and a reduced number of components.

The aforementioned aim is attained by a device for analysis by gas phase chromatography comprising at least one micro-column, at least one detector arranged in a channel connected in series with the micro-column, means for heating the micro-column and means for cooling the at least one detector, the heating means and the cooling means being formed by at least one thermoelectric module, the hot face of which forms the heating means and the cold face of which forms the cooling means.

This device has great compactness since the same element assures both the heating and the cooling.

In one embodiment, the device comprises several micro-columns each connected to a detection module. The micro-columns may all be in contact with the hot face of the thermoelectric module, or the micro-columns are superimposed, a single one then being in contact with the hot face.

The detection modules may also all be in contact with the cold face of the thermoelectric module, or be superimposed, a single module then being in contact with the cold face.

The materials of the columns and/or detection modules are good heat conductors, the whole of the stack is thus substantially at the same temperature.

In another embodiment, the device for analysis comprises several thermoelectric modules.

The subject matter of the present invention is then a device for analysis by gas phase chromatography comprising:
at least one chromatography micro-column,
at least one detection module comprising at least one NEMS and/or MEMS type detector arranged in a channel,
a direct fluidic connection between an evacuation end of the chromatography micro-column and an admission end of the channel of the detection module,

said chromatography micro-column and said detector forming an analysis sub-assembly,
means for heating the chromatography micro-column formed by a hot face of at least one thermoelectric module,
means for cooling the detection module,

the means for cooling the detection module being formed by the cold face of the thermoelectric module.

In an embodiment, the device comprises at least one first and one second thermoelectric module. In an example, a hot face of the first thermoelectric module forms the heating means, a cold face of the first thermoelectric module is in contact with a hot face of the second thermoelectric module and a cold face of the second thermoelectric module forms the cooling means.

In another example, a hot face of the first thermoelectric module forms the heating means, a cold face of the first module is in contact with a heat sink, a hot face of the second thermoelectric module is in contact with said heat sink and a cold face of the second thermoelectric module forms the cooling means.

According to an additional characteristic, the device comprising at least two analysis sub-assemblies in series.

The chromatography micro-columns may then be superimposed such that a single one of the chromatography micro-columns is in contact with the heating means.

The detection modules may be superimposed such that a single detection module is in contact with the cooling means.

In another example, the chromatography micro-columns being juxtaposed such that all the chromatography micro-columns are in contact with the heating means.

In another example, the detection modules are juxtaposed such that all the detection modules are in contact with the cooling means.

The device advantageously comprises heat insulation means at least around the module or the set of modules.

The at least one fluidic connection is preferably formed by a capillary.

The device for analysis may advantageously comprise at least one temperature sensor and/or one hygrometry sensor and/or one flow rate sensor.

Each sub-assembly is preferably functionalised for detecting one or more given analytes.

### BRIEF DESCRIPTION OF DRAWINGS

The present invention will be better understood by means of the description that follows and the appended drawings, in which:

FIG. 1 is a schematic representation of an example of a first embodiment of a device for analysis according to the invention,

FIG. 2 is a schematic representation of another example of the first embodiment of a device for analysis according to the invention,

FIG. 3 is a schematic representation of another example of the first embodiment of a device for analysis according to the invention,

FIG. 4 is a schematic representation of an example of a second embodiment of a device for analysis according to the invention comprising two thermoelectric elements,

FIG. 5 is a schematic representation of another example of a second embodiment of a device for analysis according to the invention comprising two thermoelectric elements,

FIG. 6 is a cut-away view of an example of a thermoelectric element.

### DETAILED DESCRIPTION OF PARTICULAR EMBODIMENTS

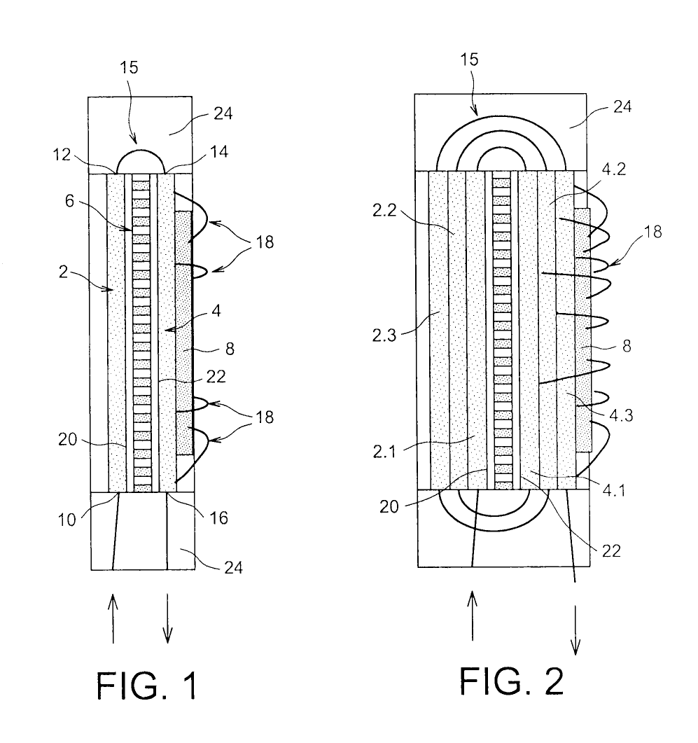

In FIG. 1 may be seen a schematic representation of an example of a first embodiment of a device for analysis according to the invention comprising a chromatography column 2, a detection module 4 and heating and cooling means 6.

In the description that follows, a chromatography column is a chromatography micro-column formed in a substrate by microelectronic techniques. A detection module comprise one or more NEMS (nanoelectromechanical system) and MEMS (microelectromechanical system) type detectors arranged in a channel, the detectors being intended to be placed in contact with the analytes separated by the chromatography micro-column. The NEMS and MEMS detectors are also formed on a substrate by microelectronic techniques.

Moreover, the terms “analyte”, “element”, “species” and “compound” are considered as synonymous and designate the gaseous compounds contained in the gas to be analysed.

The device also comprise an electronic intended to collect the signals emitted by the detectors, said electronic 8 is also borne by a substrate. The chromatography column will be designated “column” hereafter for reasons of simplicity.

The column 2 comprises an inlet end 10 and an outlet end 12. The gas to be analysed is introduced into the column via the inlet end 10 and is evacuated via the outlet end 12. The detection module 4 also comprises an inlet end 14 and outlet end 16.

The outlet end 12 of the column 2 is connected to the inlet end 14 of the detection module 4 by a fluidic connection 15.

The inlet end 10 of the column 2 is connected to a supply of sample intended to be analysed by the device for analysis. This supply is not represented.

The outlet end 16 of the detection module 4 is connected to means for recovering the sample after its analysis or said sample emerges directly into the exterior environment, for example in the case of analysis of ambient air.

Electrical connections 18 are formed between the detectors of the detection module 4 and the electronic 8.

The heating and cooling means 6 are formed by at least one thermoelectric module comprising a first face 20 and a second face 22 substantially parallel. The first face 20 forms the hot surface of the thermoelectric module and the second face 22 forms the cold surface of the thermoelectric module.

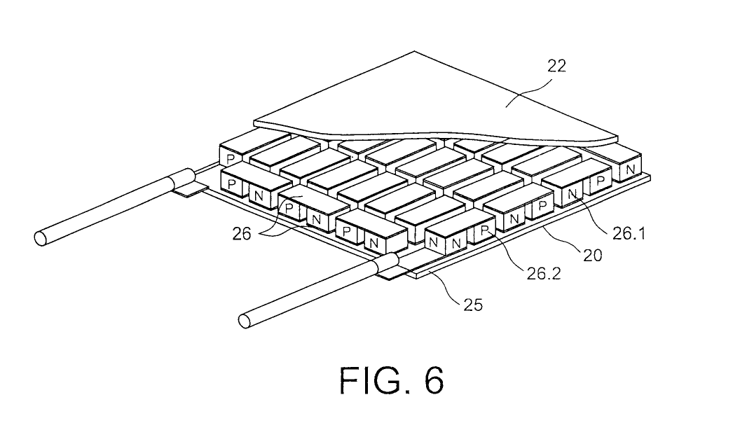

In FIG. 6 may be seen a cut-away view of an example of embodiment of a thermoelectric module able to be implemented in the device of FIG. 1.

The thermoelectric module represented in FIG. 6 comprises a substrate 25 and a plurality of p-n junctions 26 connected in series. The p-n junctions are formed by an n-doped semi-conductor material 26.1 and a p-doped semi-conductor material 26.2, the materials 26.1, 26.2 are arranged in an alternating manner and extend between the first surface 22 and the second surface 24 of the thermoelectric module 6. Interconnections are provided between the adjacent n-doped materials 26.1 and the p-doped materials 26.2 so as to form p-n junctions. When a potential difference is applied to the p-n junctions, it causes the appearance of a heat flow within the thermoelectric module and thus the appearance of a temperature difference between the face 22 and the face 24. Hereafter, it will be considered that the face 24 is the face having the lowest temperature, designated cold face and the face 22 as that having the highest temperature and designated hot face.

The column 2 is in contact with the hot face 20 and the detection module 4 is in contact with the cold face 22.

The device preferably comprises means 24 for thermally insulating the column 2, the detection module 4 and the heating and cooling means 6 with respect to the exterior environment. For example, heat insulating elements are arranged around the connections between the outlet end 12 of the column 2 and the inlet end 14 of the detection module 4 and at the inlet end of the column 2 and the outlet end 16 and the detection module 4.

The whole of the device is preferably contained in a casing facilitating its handling and protecting it.

The heat insulating materials also have the effect of thermally insulating the hot face from the cold face.

Preferably, the internal wall of the column is chemically functionalized, it is covered with a layer of material called stationary phase, for example PDMS (polydimethylsiloxane).

The detectors of the detection module 4 are also advantageously chemically functionalised.

In an advantageous manner, the device may be provided with a pre-concentrator arranged upstream of the inlet end 10 of the column 2.

In an advantageous manner, the heating and cooling means comprise temperature sensors to enable the control of heating and cooling temperatures, for example they may be platinum probes or thermocouples.

The device for analysis may also comprise in an advantageous manner flow sensors and/or hygrometry sensors arranged either inside the column and/or the detection module, or in the fluidic connections of the device for analysis. These sensors are electrically connected to the electronic 8 such that their signals are processed.

The fluidic connections are for example formed by means of capillary tubes, for example silica capillary tubes.

The electrical connections between the detection module, the different sensors and the electronic are for example formed by “wire bonding”, which is a method well known to those skilled in the art of micro-electronics and which will not be described in detail.

In a variant, it could be envisaged to form these electrical connections by a method known as “flip hip” which consists in using conductive beads placed directly between the substrate on which are formed the detectors and the electronic substrate. This method is also well known to those skilled in the art and will not be described in detail in the present application. The functioning of the device for analysis of FIG. 1 will now be described.

The device is connected to a supply of sample to be analysed, this sample is injected into the column 2 via the inlet end 10. Beforehand, the heating and cooling means 6 have been activated such that a flow of heat appears through the thermoelectric module. The result is a heating of the column 2 that is in contact with the hot face 22 of the thermoelectric module and a cooling of the detection module 4 that is in contact with the cold face 24 of the thermoelectric module.

The sample thus circulates in the column 2, the stationary phase causes a separation of the different components of the gaseous sample, these components separated within the column then enter into the detection module wherein they are detected by the different detector(s), the signals emitted by these detectors are processed by the electronic, which generates for example a graph comprising a series of peaks separated over time, the size of which is indicative of the concentration of each of the elements composing the gaseous sample. It is the time separating the injection of the gaseous sample and the appearance of the peak that makes it possible to identify the nature of the gas after calibration.

Thanks to the heating of the column 2, the spatial separation of species is improved, and thanks to the cooling of the detectors of the detection module 4 the effect of trapping of the gaseous compounds by physisorption is improved. This trapping is favoured when the temperature is below ambient temperature from 10° C. to 20° C.

As an example, the column is heated to a temperature of the order of 70° C. and the detection module is cooled to a temperature of 5° C.

Thanks to the invention, the device for analysis has great compactness since it uses the same element for heating the column and for cooling the detectors. A reduction in the electrical energy consumption required for heating and cooling ensues since the heating and the cooling are obtained simultaneously by a single supply of the thermoelectric element. In fact, all the heat dissipated by the thermoelectric module is fully used to heat the column. This is all the more efficient when the device is isolated from the exterior environment to limit heat losses.

The great compactness of the device moreover has the advantage of reducing the length and the number of fluidic connections, which has the effect of reducing the head losses, the dead volumes, and also makes it possible to improve the control of the temperature.

In FIG. 2 may be seen another example of the first embodiment of the device for analysis, this comprising several chromatography columns and several detection modules.

In this embodiment example, the device comprises three superimposed chromatography columns and three superimposed detection modules fluidically connected in series. The three chromatography columns: 2.1, 2.2, 2.3, are superimposed such that the column 2.1 is in direct contact with the hot face 22 of the thermoelectric module 6, that the second column 2.2 is in direct contact with the face of the first column 2.1 opposite to that in contact with the hot face 20 and that the third column 2.3 is in contact with the other face of the second column 2.2. The three detection modules 4.1, 4.2, 4.3 are electrically connected to the electronic.

The three detection modules 4.1, 4.2 and 4.3 are superimposed in a similar manner, only the detection module 4.1 is in direct contact with the cold face 24 of the thermoelectric module 6. Moreover, the first column 2.1 is connected in series directly with the first detection module 4.1 which is connected at its outlet to the inlet of the second column 2.2, itself connected at its outlet to the inlet of the second detection module 4.2, which is connected at its outlet to the inlet of the third column 2.3 connected at its outlet to the inlet of the third detection module 4.3 the outlet of which is connected to a system for recovering the gaseous sample. Thus, the gaseous sample when it is injected into the inlet of the first column 2.1 flows successively into the column 2.1, into the detection module 4.1, into the column 2.2, into the detection module 4.2, into the column 2.3, and finally into the detection module 4.3 before being evacuated.

In this embodiment, the heating of the second and third columns takes place by conduction through the first column 2.1 in direct contact with the hot face 20 and the cooling of the detectors 4.2 and 4.3 takes place by conduction through the detection module 4.1 in direct contact with the cold face 22.

It will be understood that the chromatography columns 2.1, 2.2, 2.3 may have lengths and diameters different to each other as well as a different chemical functionalization, in other words a different stationary phase and the detection modules may be identical or different, be made of different materials, geometries, and also have different chemical functionalizations.

This embodiment is particularly interesting in the case of the present invention on account of the great compactness and the reduced length of the fluidic connections obtained thanks to the implementation of a thermoelectric element. The head losses and dead volumes are reduced and the control of temperature is improved.

The device for analysis of FIG. 2 offers improved resolution, since each detection module is dedicated to the analysis of a category of compounds.

In view of the much reduced size of the assembly, it is assumed that there is no notable temperature difference between the column arranged directly in contact with the hot face and the other columns and between the set of detectors directly in contact with the cold face, and the other sets of detectors. Moreover, the materials of the columns and/or the detection modules may be chosen to be good heat conductors, the whole of the stack is then substantially at the same temperature.

In a variant, it could be wished to obtain a temperature gradient, for this it may be envisaged to intercalate insulating materials between the columns, and between the sets of detectors.

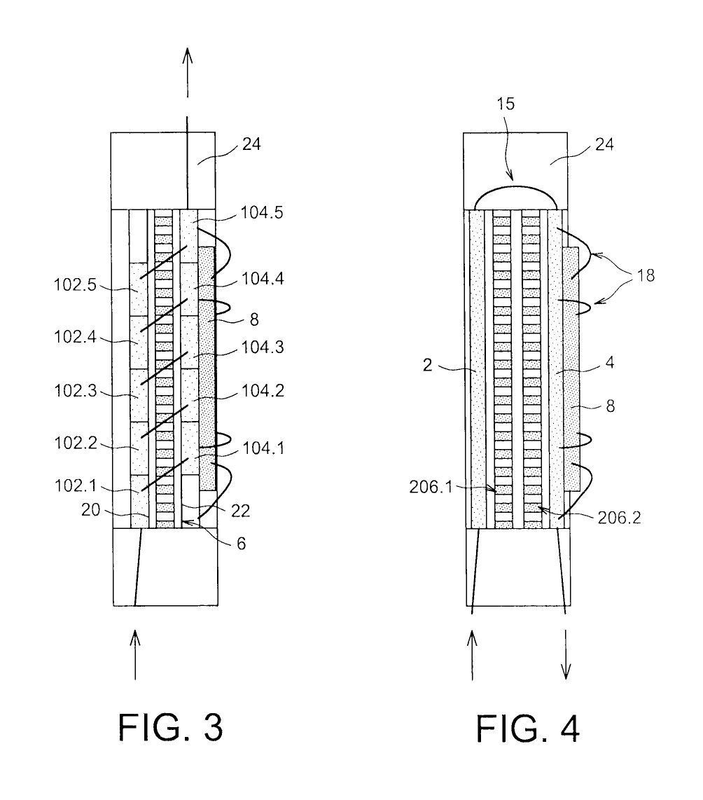

In FIG. 3, another example of the first embodiment may be seen.

The device of FIG. 3 also comprises several columns and several detection modules. This device differs from that of FIG. 2 in that all of the columns are in direct contact with the hot face 22 of the thermoelectric module 6, and all of the detection modules are in direct contact with the cold face 24 of the thermoelectric module 6.

In the example represented, the device comprises five columns: 102.1 to 102.5 and five detection modules 104.1 to 104.5. The first column 102.1 is supplied by a device for supplying with analysed sample and is connected in series to a first detection module 104.1 through the intermediary of a fluidic connection that straddles the thermoelectric module laterally, then the first detection module 104.1 is connected at the outlet to the inlet of the second column 102.2 by a fluidic connection laterally straddling the thermoelectric module 4 (this connection is not visible in the representation of FIG. 3). The columns and the detection modules are connected in a similar manner and the fifth detection module 104.5 is connected at the outlet to the device for recovering the sample.

This device has the advantage that all of the columns are in contact directly with the hot surface and thus show the same temperature and that all of the detection modules are in direct contact with the cold face and thus show the same temperature.

As for the example of FIG. 2, this device for analysis has improved sensitivity since each detection module is dedicated to the detection of a category of compounds. And as for the device of FIG. 2, the columns are not necessarily identical in structure and in chemical functionalization as well as detection modules.

The functioning of the device of FIG. 3 is similar to that of the device of FIG. 2.

In FIG. 4 may be seen an example of a second embodiment of a device for analysis according to the present invention wherein two thermoelectric elements are implemented.

In this embodiment, the heating and cooling means comprise two thermoelectric elements 206.1 and 206.2. The hot face of the thermoelectric module 206.1 is in contact with at least one column 4 and the cold face of the thermoelectric module 206.2 is in direct contact with at least one detection module. The cold face of the thermoelectric module 206.1 is in direct contact with the hot surface of the thermoelectric module 206.2. These heating and cooling means make it possible to increase the temperature difference between the cold surface and the hot surface of the cooling and heating means. For example, for the temperature difference may be increased from 65° C. to 95° C., the cold surface being at −5° C. and the hot surface at 90° C.

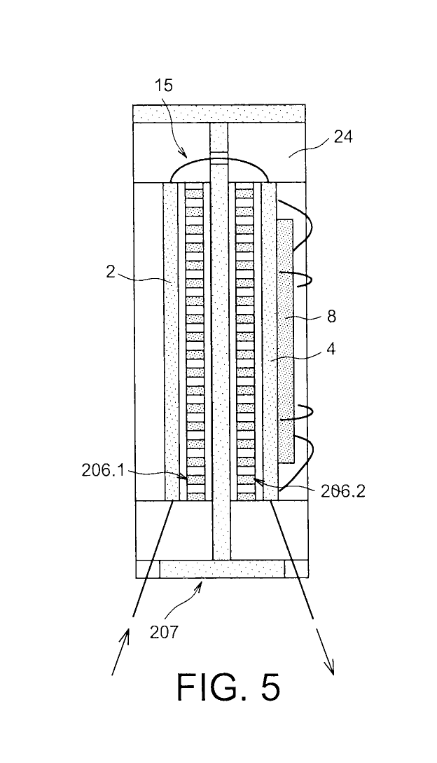

In FIG. 5 may be seen another example of the second embodiment wherein the heating and cooling means comprise two thermoelectric elements. These means differ from those implemented in the device of FIG. 4 in that the heat dissipation means 207 are interposed between the two thermoelectric elements. The heat dissipation means are for example formed by a radiator made of material offering good heat conduction, one face of which is in direct contact with the hot surface of the thermoelectric module 206.2 and another face is in direct contact with the cold surface of the thermoelectric module 206.1. The dissipation means are for example made of copper or aluminium.

These heating and cooling means make it possible to adjust separately the hot and cold temperatures and to do so independently of the ambient temperature. The functioning is similar to that described in relation to the device of FIG. 1.

The heating and cooling means implemented in the devices of FIGS. 4 and 5 may be implemented in the devices of FIGS. 2 and 3, in other words in devices comprising several columns and several sets of detectors.

Moreover, it may be envisaged to combine the structures of the devices of FIGS. 2 and 3. For example, the device for analysis could comprise superimposed columns and juxtaposed sets of detectors or vice versa.

Moreover, in particular, in the device of FIG. 4, it may be envisaged to implement more than two thermoelectric elements if it is wished to further accentuate the temperature difference between the cold temperature and the hot temperature.

As an example, the array of detectors may have dimensions comprised between 2×2 mm and 10×20 mm.

The column may have dimensions comprised between 10×10 mm and 30×30 mm.

The device may be manufactured entirely by microelectronic techniques.

As an example, the different elements of the device are formed independently and assembled by an adhesive such as a heat conducting epoxy or by mechanical assembly, particularly with clamps. In the latter case, to improve heat conduction between the different elements, a thermal grease or a thermal seal may be added.

The detection device according to the present invention offers great compactness and a high detection performance. It is particularly adapted to nomadic use.

The detection device may for example be used in the medical field, in laboratories, in safety devices and in fields linked to the environment.

1. Device for analysis by gas phase chromatography comprising:
at least one chromatography micro-column,
at least one detection module comprising at least one NEMS and/or MEMS type detector arranged in a channel,
a direct fluidic connection between an evacuation end of the chromatography micro-column and an admission end of the channel of the detection module,
said chromatography micro-column and said detector forming an analysis sub-assembly,
a hot face of at least one thermoelectric module being configured to heat the chromatography micro-column formed by
the cold face of the thermoelectric module being configured to cool the detection module,

2. Device for analysis according to claim 1, comprising at least one first and one second thermoelectric module.

3. Device for analysis by gas phase chromatography comprising:
at least one chromatography micro-column,
at least one detection module comprising at least one NEMS and/or MEMS type detector arranged in a channel,
a direct fluidic connection between an evacuation end of the chromatography micro-column and an admission end of the channel of the detection module,
said chromatography micro-column and said detector forming an analysis sub-assembly,
wherein a hot face of at least one first thermoelectric module begin configures to heat the chromatography micro-column,
wherein the cold face of a second thermoelectric module being configured to cool the detection module, and
wherein a cold face of the first thermoelectric module is in thermal contact with a hot face of the second thermoelectric module.

4. Device for analysis according to claim 3, wherein the cold face of the first thermoelectric module is in direct contact with the hot face of the second thermoelectric module.

5. Device for analysis according to claim 3, wherein a cold face of the first thermoelectric module is in contact with a heat sink, a hot face of the second thermoelectric module is in contact with said heat sink and a cold face of the second thermoelectric module being configured to cool the detection module.

6. Device for analysis according to claim 1, comprising at least two analysis sub-assemblies connected in series.

7. Device for analysis according to claim 6, wherein the chromatography micro-columns being superimposed such that a single one of the chromatography micro-columns is in contact with the hot face of the first thermoelectric module.

8. Device for analysis according to claim 6, wherein the detection modules are superimposed such that a single detection module is in contact with the cold face of the second thermoelectric module.

9. Device for analysis according to claim 6, wherein the chromatography micro-columns being juxtaposed such that all the chromatography micro-columns are in contact with the hot face of the first thermoelectric module.

10. Device for analysis according to claim 6, wherein the detection modules are juxtaposed such that all the detection modules are in contact with the cold face of the second thermoelectric module.

11. Device for analysis according to claim 6, wherein each of the at least two sub-assemblies is functionalized for detecting one or more given analytes.

12. Device for analysis according to claim 1, comprising a thermal insulator at least around the thermoelectric module or the at least first and second thermoelectric modules.

13. Device for analysis according to claim 1, wherein the at least one fluidic connection is a capillary.

14. Device for analysis according to claim 1, comprising at least one temperature sensor and/or one hygrometry sensor and/or one flow rate sensor.

15. Device for analysis according to claim 7, wherein the detection modules are superimposed such that a single detection module is in contact with the cold face of the second thermoelectric module.

16. Device for analysis according to claim 9, wherein the detection modules are juxtaposed such that all the detection modules are in contact with the cold face of the second thermoelectric module.

17. Device for analysis according to claim 3, comprising at least two analysis sub-assemblies connected in series.

18. Device for analysis according to claim 17, wherein the chromatography micro-columns being superimposed such that a single one of the chromatography micro-columns is in contact with the hot face of the first thermoelectric module.

19. Device for analysis according to claim 17, wherein the detection modules are superimposed such that a single detection module is in contact with the cold face of the second thermoelectric module.

20. Device for analysis according to claim 17, wherein the chromatography micro-columns being juxtaposed such that all the chromatography micro-columns are in contact with the hot face of the first thermoelectric module.

21. Device for analysis according to claim 17, wherein the detection modules are juxtaposed such that all the detection modules are in contact with the cold face of the second thermoelectric module.

22. Device for analysis according to claim 17, wherein each of the at least two sub-assemblies is functionalized for detecting one or more given analytes.

23. Device for analysis according to claim 3, comprising thermal insulator at least around the thermoelectric module or the at least first and second thermoelectric modules.

24. Device for analysis according to claim 3, wherein the at least one fluidic connection is a capillary.

25. Device for analysis according to claim 3, comprising at least one temperature sensor and/or one hygrometry sensor and/or one flow rate sensor.

26. Device for analysis according to claim 18, wherein the detection modules are superimposed such that a single detection module is in contact with the cold face of the second thermoelectric module.

27. Device for analysis according to claim 20, wherein the detection modules are juxtaposed such that all the detection modules are in contact with the cold face of the second thermoelectric module.
